(19) United States
(12) Patent Application Publication
(10) Pub. No.: US 2002/0165338 A1
(43) Pub. Date: Nov. 7, 2002

(54) Method for making high molecular weight, extended pi-conjugated polymers

(76) Inventors: Brett D. Martin, Alexandria, VA (US); Charles H. Patterson JR., Laurel, MD (US)

Correspondence Address: NAVAL RESEARCH LABORATORY, ASSOCIATE COUNSEL (PATENTS), CODE 1008.2, 4555 OVERLOOK AVENUE, S.W., WASHINGTON, DC, 20375-5320, US

(21) Appl. No.: 09/849,490

(22) Filed: May 4, 2001

(51) Int. Cl. C08G 75/00; C08G 75/06

(52) U.S. Cl. 528/377; 528/378; 528/380; 528/384; 528/486; 528/491; 528/86

(57) ABSTRACT

A process for making a high molecular weight, extended π-conjugated polymer from a monomer comprising a heterocyclic, benzylic or phenolic ring is described. The process comprises reacting a Lewis acid with:

a. the monomer and

b. a polyhydroxy moiety, the polyhydroxy moiety being linked covalently to the monomer or present in free form.

### BACKGROUND OF THE INVENTION

1. Field of the Invention

The present invention relates to a polymerization process for making high molecular weight polymers containing extended π-conjugated orbitals, in particular those that exhibit a UV/visible spectrum or are conducting, or both. The polymers made by the process of this invention are, at least, potentially useful in micro- and nanoscale electronics, photonics, non-linear optics, electrochromic displays, lightweight storage batteries, corrosion protection coatings, conductive thermoplastics, bio- and chemical sensors, artificial muscles, and aerospace applications, such as microwave-absorbing materials.

2. Description of the Prior Art

In general, very high molecular weight, conjugated polymers are of great value, because they usually lead to desirable properties, such as increased mechanical strength and elasticity. These characteristics are important in military and commercial devices, such as coatings and shields for large surface (i.e., corrosion protection coatings and radar-absorbing shields).

Other key properties of π-conjugated organic materials, such as conductivity, band gap, work function values, dielectric constant, and oxidation potential, can be varied over much wider ranges than those of state-of-the-art inorganic materials, such as indium, tin oxide and silicon. This is due to the vast diversity inherent in the organic chemistry of π-conjugated monomers. Other advantages over metals and inorganic semiconductors include great plasticity and elasticity, lower mass density, lower coefficient of thermal expansion, greater resistance to chemicals and corrosion, electrochromism, and enhanced power storage capabilities.

For the past ten years or so, there has been an especially keen interest in “conducting” polymers. For example, their use as organic light-emitting diodes (OLEDs) are an attractive alternative to liquid crystal display technology because they can yield displays that are brighter, lower cost, consume less power, and are lightweight. Other examples of commercial interests in conducting polymers are as anticorrosion coatings and printed circuit board finishes.

The bulk properties of π-conjugated oligo- and polymeric materials depend heavily on the degree of entropic order present within each polymer chain, and between the chains as well. The former reflects the degree of regioregularity in the bond placement between polymer repeat units (covalent intrachain order). The latter reflects the degree of chain stacking and spontaneous self-assembly (noncovalent interchain order). In general, important materials properties are greatly enhanced if the polymer possesses a high degree of both intra- and interchain order.

Intrachain Order

Bulk properties such as electroactivity, conductivity, and photoactivity, almost always require maximum level of conjugation within individual polymer or oligomer chains. Long conjugation lengths, in turn, depends upon the appropriate ordering of covalent linkages between the repeat units, preferably allowing each repeating unit to adopt a quinoid form. For polyphenylene and polyheterocycles, such as those based on thiophene and pyrrole, for example, the proper ordering is best attained when the repeat units are linked via the 2- and 5- positions of the aromatic ring.

Simple chemical oxidants such as iron trichloride have been used to form oligomers and polymers from benzene, thiophene, pyrrole, and their derivatives. The chemical oxidants are easy to use, but are not necessarily selective towards the formation of the particularly desirable 2,5-linkage patterns. For example, for thiophene and pyrrole, 2,4-; 2,3-; 5,4-; and 5,3-linkages may result as well. Only one case is known involving a 3-substituted heterocycle in which a chemical oxidant (iron trichloride) has enabled the formation of a strictly regular 2,5-linked polymer. Jonas et al., U.S. Pat. No. 4,987,042. Far more commonly, iron trichloride and other oxidants, such as molybdenum pentachloride and ruthenium trichloride, yield polymers with only partial 2,5-regioregularity and low to moderate molecular weight. In addition, the use of strong oxidants is proscribed if the monomer is derivatized with oxygen-sensitive non-polymerizing functional groups.

The most general route to strictly ordered 2,5-linked oligomers and polymers entails the use of highly specific (AA-BB) monomer coupling strategies, such as Suzuki or Stille coupling. The organometallic catalysts used in these methods are tolerant towards a wide variety of fictional groups that may be present as part of the monomer structure, but not involved in 2,5-linkage formation. However, coupling reactions such as these have other limitations. For example, synthesis of the activated form of the monomer is not always straightforward, and the procedures often require harsh reagents, such as n-butyllithium. Further, several steps are often required, resulting in low overall yields. Further still, the AA/BB monomer ratio must be precisely controlled during polymerization or a polydisperse low molecular weight product will result.

In another strategy for achieving the desirable 2,5-conjugative linkages, the monomer is simply designed so that all positions on the aromatic ring are blocked except for those at the 2- and 5-positions. Covalent bond formation and chain extension are then forced to proceed via the remaining open positions. An important example of this type of monomer is 3,4-ethylenedioxythiophene (EDOT). EDOT comprises a thiophene ring that is substituted with oxygen at both the 3- and 4-ring positions. The oxygen atoms donate electron density to the thiophene ring, thus helping to stabilize the desired quinoid form. Oligomers and polymers of EDOT formed in small-scale electrochemical syntheses are highly conjugated and exhibit excellent electroactivity. During the early stages of a typical large-scale chemical synthesis of poly(EDOT), however, EDOT oligomers become insoluble as the number of repeat units exceeds five or six, a drawback shared with oligomers based on thiophene and pyrrole.

Low-molecular weight poly(EDOT) has been synthesized from monomeric EDOT, but poly(styrenesulfonate), a polyanion, must be present in large quantities for the resulting poly(EDOT) to remain soluble. To reach higher molecular weights, covalent derivatization of the monomer is usually required. This may be done, for example, by attaching a conformationally flexible n-alkyl group at a ring position that does not interfere with conjugation. This permits the growing oligomer/polymer chains to remain soluble, to achieve extended chain growth, and yet still be processable after synthesis. However, the covalent attachment of these large solubility-enhancing moieties adds a significant amount of inert mass to the final polymer product, reducing material performance accordingly.

Interchain Order

When desirable traits such as electroactivity, conductivity, and photoactivity do exist in π-conjugated organic polymers, they depend largely on long conjugation lengths. These desirable traits can be further enhanced if cation and electron transport can occur, not only along the length of the polymer chains, but also in directions orthogonal to the chains. When the polymer chains are properly ordered with respect to each other, π-bond interactions (π-stacking) between neighboring chains provide an enhanced pathway for orthogonal charge movement. This interchain order originates from related interactions between carbon atoms on a given chain and any heteroatoms (e.g., S or N) present on neighboring chains. This π-stacking behavior is highly sensitive to the presence of coordinated metals, and is also affected by the polarity of covalently attached functional groups. In addition, π-stacking may fortuitously arise from other functional groups introduced into the monomer, such as those intended for solubility enhancement. Finally, it may also arise from the self-assembly of intentionally designed hydrogen-bonding moieties that are attached to the chains.

Thus far, the use of self-assembly strategies for high-performance conjugated materials has generally been on a very small scale using low molecular weight oligomers. For example, polymeric films have been formed with a thickness of only a few nanometers to a few microns. Several studies of derivatized poly(terephthalates)s have arisen from significant commercial interests in conductive coatings for next-generation thin plastic computer displays. Other investigations have examined the performance of derivatized poly(terephthalates)s as coatings for electronics components, and as construction materials for field-effect transistors, both applications requiring very small amounts of material. The self-ordering oligomers/polymers in these examples arose from relatively unsophisticated strategies using n-alkyl derivitized oligo- or poly(terephthalate) or urea derivatized oligo(terephthalate). The materials did exhibit higher conductivities and electroactivities than related, unordered oligo(terephthalates)s, but the degrees of induced order appeared to be far short of what could be attained using more sophisticated ordering strategies.

The synthesis of high molecular weight, conjugated polymers remains extremely difficult, largely due to solubility problems arising from the “rigid rod” nature of the conjugated chain molecules. Accordingly, there still exists a clear need for a polymerization method that permits the growing “rods”, or conjugated chains, to remain well-solvated during chain elongation, thus enabling them to attain very high molecular weights.

### SUMMARY OF THE INVENTION

The process of the invention is for preparing a high molecular weight, extended π-conjugated polymer from a monomer comprising a heterocyclic, benzylic or phenolic ring. The process comprises reacting a Lewis acid with:

a. the monomer and

b. a polyhydroxy moiety, the polyhydroxy moiety being linked covalently to the monomer or present in free form.

By this method, π-conjugated polymers of unusually high molecular weight can be prepared from covalently derived and underived aromatic monomers. Further, the method is widely applicable to a variety of different monomers and requires only mild oxidants and reaction conditions. Further still, the polymers produced are typically soluble, processable, and capable of reversible self-assembly, and may be conducting.

### BRIEF DESCRIPTION OF THE DRAWINGS

FIGS. 1a, 1b and 1c show GPC chromatograms for three polymers synthesized according to the invention using scandium triflate [1a=β-O-2-(3-thienylethyl) glucopyranoside; 1b=poly(3-methyl thiophene) in the presence of β-O-methyl glucopyranoside; and 1c=poly(3-methyl thiophene) alone].

FIGS. 2a, 2b and 2c show UV/visible spectra of polymers synthesized according to the invention using scandium triflate [2a=β-O-2-(3-thienylethyl) glucopyranoside; 2=poly(3-methyl thiophene) in the presence of β-O-methyl glucopyranoside; and 2=poly(3-methyl thiophene) alone].

FIG. 3 shows a GPC chromatogram for poly(3,4-ethylenedioxythiophene) synthesized using scandium triflate and β-O-methyl glucopyranoside.

FIG. 4 shows a UV/visible spectrum for poly(3,4-ethylenedioxythiophene) synthesized using scandium triflate and β-O-methyl glucopyranoside.

FIG. 5 shows a matrix of control experiments.

FIGS. 6a and 6b show the ¹H-NMR chemical shifts and spectrum of β-O-2-(3-thienylethyl) glucopyranoside.

FIG. 7 shows the ¹H-NMR spectrum of oligo(β-O-2-(3-thienylethyl) glucopyranoside at t=30 minutes.

FIG. 8 shows the ¹H-NMR spectrum of oligo(β-O-2-(3-thienylethyl) glucopyranoside at t=210 minutes.

FIG. 9 shows the UV/visible spectrum of poly(2,3-TEG) in various solvents.

### DETAILED DESCRIPTION OF THE INVENTION

The monomer used to prepare the high molecular weight extended β-conjugated polymer of the invention is comprised of a heterocyclic, benzylic or phenolic ring and may have a plurality of covalently linked hydroxy groups. Useful examples of such heterocyclic rings include thiophene, 3,4-alkylenedioxythiophenes such as 3,4-ethylenedioxythiophene, benzothiophene, naphtho[2,3-b]thiophene, furan, pyran, isobenzofuran, 2H-pyrrole, pyrrole, imidazole, pyrazole, indolizine, isoindole, 3H-indole, indole, 1H-indazole, purine, isothiazole, isoxazole, furazan, and the like. Useful examples of benzylic and phenolic structures include hydroquinone, 1,4-dihydroxy-2,5-dimethyl benzene, 1,2,4-trihydroxy benzene, 1,2-dihydroxybenzene, 1,3-dihydroxybenzene, 4-hydroxytoluene and the like. The monomer of the invention preferably comprises a heterocyclic ring that is capable of assuming a roughly quinoid form upon polymerization. In some cases, the monomer of the invention may contain both a heterocyclic ring and a phenolic or benzylic ring. In preferred embodiments, the monomer of the invention contains a thiophene, pyrrole, furan or hydroquinone ring and, most preferably, a thiophene ring, optionally covalently linked to a polyhydroxy moiety.

Specific examples of particularly preferred monomers include thiophene, pyrrole, 3-methyl thiophene, 3-thienylethanol, 3,4-ethylenedioxy thiophene, β-O-2-(3-thienylethyl) glucopyranoside, and β-O-2-(2,3 dihydrothieno-[3,4-b][1,4]dioxin-2-yl)methyl) glucopyranoside. The structures of four of these preferred compounds are provided below:

β-O-(2,3 dihydrothieno [3,4-b][1,4]dioxin-2-yl)methyl glucopyrano side

In the process of the invention, a Lewis acid is combined with the monomer. The Lewis acid of the invention may be any recognized Lewis acid, such as compounds having a central atom cation with an incomplete octet and an anion that is a good leaving group. Examples of such Lewis acids include Sc(OTr)₃ where “OTr” is the rifluoromethanesulfonate (“triflate”) anion; La(OTr)₃; Y(OTr)₃; Cu(OTr)₃; Zn(OTr)₃; Al(OTr)₃; Gd(OTr)₃; Eu(OTr)₃; Tm(OTr)₃; Lu(OTr)₃; BF₃; AlCl₃; FeBr₃; MgBr₂ and the like. Preferably, the Lewis acid of the invention comprises a metal cation having a valence of +3, particularly those that are the Group 3 elements, the Group 13 elements, or Lanthanides. In particularly preferred embodiments, the Lewis acid cation is selected from the group consisting of scandium and lanthanum, and the anion is a trifluoromethane sulfonate (triflate) anion.

The polyhydroxy moiety of the invention may be covalently linked to the monomer, as in β-O-2-(3-thienylethyl) glucopyranoside, or it may be present in free form as a separate compound that is not covalently linked to the monomer. Further, a separate compound comprising a polyhydroxy moiety may be present in the reaction mixture even when the monomer is also covalently linked with a polyhydroxy group. The polyhydroxy moiety is thought to have three roles that influence the synthesis, processing, and molecular ordering of extended π-conjugated polymers. It acts as (1) a monomer/polymer solubility-enhancing agent, (2) a Lewis acid activator or attenuator, and (3) an important component in the reversible self-assembly of the resulting polymer chains.

First, the polyhydroxy moiety promotes the solubility of both the monomer and the growing polymer chains, and it can be derivatized to further enhance this ability. For example, diverse functional groups, such as aglycons, may be substituted at anomeric center of the polyhydroxy moiety to tailor its particular solvation and complexation properties to the requirements of the particular monomer being used to produce a particular polymer.

As a Lewis acid activator, it is possible that, when the polyhydroxy moiety coordinates to the anion-substituted Lewis acid, and the anion is displaced, the Lewis acid becomes exposed, and its oxidation power is increased. The exposure is thought to arise from the smaller molecular weight of the displacing polyhydroxy moiety, as compared with the departing anions, and from the asymmetric coordination of the alcohol, as compared to the symmetrical coordination of the original anions (believed to be trigonal planar). By activating the Lewis acid, which acts as a catalyst, the polyhydroxy moiety significantly increases its ability to form carbon-carbon bonds.

It is also possible that, for particular Lewis acids, the polyhydroxy moiety acts to attenuate (vs. activate) the catalytic activity of the acid. This may occur if the polyhydroxy moiety coordinates directly to the acid and shields it, rather than displacing the counteranions.

The polyhydroxy moiety can also be derivatized, at a time before, during or after polymer formation, to enhance the reversible self-assembly of the polymer chains. The polyhydroxy moiety may be recognized by various biological systems and thus may even act as an interface, for example, between a particular protein and the conductive π-conjugated polymer of the invention.

The polyhydroxy moiety may be any of a wide variety of different polyhydroxy moieties, such as poly(vinyl alcohol); aldoses, such as erythrose, threose, ribose, arabinose, xylose, lyxose, allose, altrose, glucose, mannose, dulose, idose, galactose and talose; ketoses such as erythrulose, ribulose, xylulose, psicose, fructose, sorbose, tagatose; di-, tri-, tetra-, or pentahydroxybenzene; di-, tri-, tetra- or pentahydroxytoluene; di-, tri-, tetra or pentahydroxy cyclohexane; di-, tri- or tetrahydroxypyran or -pyrrole; di- or tri- or pentahydroxy pyridine or -pyrizine; di-, tri- or tetra-cyclopentadiene; pyranoses such a glucopyranose; furanoses such as fructofuranose; fucosides, furanosides and pyranosides such as the glucopyranosides; sugar alcohols such as glycerol, threitol, sorbitol, mannitol and inositol; sugar acids such as gluconic acid, glucaric acid, glucuronic acid and ascorbic acid; lactones such as gluconolactone; phosphoric acid esters such as glucose 1-phosphoric acid, glucose 6-phosphoric acid, fructose 1,6-diphosphoric acid; fructose 6-phosphoric acid; amino sugars such as glucosamine and galactosamine, N-acetylneuraminic acid, N-acetylmuramic acid and hyaluronic acid; disaccharides such as maltose, lactose and sucrose; and the like. The polyhydroxy compound may be a diol such as 2-(2-hydroxyethoxy)ethanol, thiodiethanol, or an aliphatic diol such as ethylene glycol, propylene glycol, 1,4 butanediol, and the like.

Preferably, the polyhydroxy moiety is a pentose or a hexose, more preferably a hexopyranose and, most preferably, β-O-methyl glucopyranoside or β-O-n-octyl glucopyranoside.

During the process of polymerization of the invention, if the polyhydroxy moiety is covalently linked to the monomer, the anion-complexed Lewis acid is believed to coordinate to the polyhydroxy-linked monomer in a polar solvent. Upon coordination, the anion of the Lewis acid is thought to be displaced by the electron-rich polyhydroxy moiety and monomer moieties. It is believed that the Lewis acid cation is simultaneously coordinated to the polyhydroxy moiety and the monomer moieties in a “sandwich” fashion. Under these conditions, a complex having a 1:1 molar ratio between Lewis acid and polyhydroxy moiety is thought to be formed. When purified polymer is subjected to elemental analysis, the results indicate that the material consists entirely of polyhydroxy moiety, the π-conjugated

ring system, and the complexed Lewis acid cation. These results suggest that the molar ratio of these three moieties is about 1:1:1.

Alternatively, a free (not covalently linked) polyhydroxy moiety may be first combined with an anion-substituted Lewis acid without the monomer being present. Upon coordination to the Lewis acid, the polyhydroxy moiety is again thought to displace the anion. When the monomer is then added, a noncovalent complex is then formed, consisting of monomer, Lewis acid cation, and polyhydroxy moiety. As above, it is believed that the Lewis acid cation is simultaneously coordinated to the polyhydroxy moiety and the monomer moieties in a “sandwich” fashion.

The solvent used in the process of the invention preferably comprises at least one polar solvent. Examples of such solvents include methanol, ethanol, acetonitrile, methyl ethyl ketone, propylene carbonate, tetrahydrofuran, dimethylformamide, and the like. However, minor amounts of one or more supplemental solvents can also be included, for example, halogenated solvents such as dichloroethane, dichloromethane, chloroform, or any of a wide variety of other organic solvents.

When using a supplemental solvent, a useful set of parameters for selecting a suitable supplemental solvent includes:

1. inertness to the polymerization reaction;

2. at least substantial solubility for all reactants used in the polymerization;

3. relatively high boiling point so that the polymerization reaction may be performed at elevated temperature if advantageous; and

4. good solubility of the polymer formed during the polymerization in the presence of the polyhydroxy moiety, to promote the formation of long polymer chains and, thus, to achieve high molecular weight.

By “substantially solubilility” is meant that, usually, at least upon heating, the Lewis acid, the monomer and the polyhydroxy moiety (if not covalently linked to the monomer) dissolve in the solvent and remain completely dissolved at the reaction temperature used in the process, or the reaction mixture becomes only somewhat cloudy. Cloudiness of the solution of the reactants in the solvent may be observed before the reaction temperature, if above room temperature, is reached. Some degree of insolubility of the monomer or the Lewis acid, in particular, can be tolerated so long as a significant proportion of the monomer remains in solution and is available for polymerization.

The amount of solvent used in the process of the invention can vary widely but is usually greatly in excess of the molar amounts of the reactants present to ensure uniform distribution of the reactants. For example, the amount of solvent is sufficient to provide a reaction mixture that is in the range of about 0.5-5.0M with respect to the monomer, preferably within the range of about 0.1M -0.3M with respect to the monomer and, most preferably, about 0.2M with respect to the monomer. This amount of solvent is also usually sufficient to provide Lewis acid solutions of comparable molarities.

Whether the polyhydroxy moiety is covalently linked or free, the addition of an organic salt appears to cause the complex to polymerize more rapidly via carbon-carbon bond formation between the rings of the monomer moieties. When the polyhydroxy moiety is covalently linked to the monomer, it is desirably well-solvated by the polar solvent. The growing polymer chains thus remain in solution, rather than precipitating out of the reaction mixture. This encourages maximum chain elongation and, thus, high polymer molecular weights. Even when the polyhydroxy moiety is free, however, the addition of an organic salt usually causes the complex to polymerize more quickly. Therefore, because the well-solvated, complexed polyhydroxy moiety maintains the growing polymer chains in solution, the resulting polymers can attain significantly higher molecular weights.

The organic salts used are highly soluble in these polar organic solvents and are non-nucleophilic. Typical organic salts employed include tetrabutylammonium hex afluorophosphate (Bu₄N/PF₆), tetrabutylammonium tetrafluorboronate, sodium lauryl sulfate, cetyl pyridinium chloride, and the like. The salt is preferably added after the formation of the polyhydroxy moiety-Lewis acid-monomer complex. The purpose of the organic salt is to promote carbon-carbon bond formation between monomer molecules by stabilizing and propagating a balancing positive charge within the π-conjugated ring system. The salt is thought to offer a suitable counterion to the ring-bound cation and, thus, raise the ionic strength of the reaction mixture. While the polyhydroxy moiety-Lewis acid-monomer complex may still oligomerize in the absence of an organic salt, the presence of the salt typically accelerates oligo- and polymerization by about one order of magnitude. For this reason, it is believed that the organic salt can be accurately characterized as an oligomer or polymer chain-growth accelerator.

The temperature at which polymerization is carried out can vary widely between about 0° C. and about 60° C., but preferably ranges from about room temperature to about 45° C. The reaction temperature should not be so low that the monomer is substantially insoluble in the solvent being used in the reaction mixture. On the other hand, the temperature should not be so high as to allow significant volatilization of the solvent during the process. Between these two limits, the reaction temperature is largely a matter of convenience and is, most conveniently, around the reflux temperature of the solvent being used for the reaction. For example, a temperature slightly above room temperature, e.g., about 35° C., is often convenient.

The time required for the polymerization reaction can also vary widely. Typically, the polymerization time is increased as needed to achieve the desired molecular weight. For example, the reaction can be monitored by GPC and simply continued until the molecular weight reaches the desired value. However, the reaction time in the invention is usually significantly shortened with the presence of the organic salt as an accelerator, while still achieving unexpectedly high molecular weights. As a general matter, the reaction time should not be so short that the desired molecular weight is not achieved, but also should not be so long that the reaction mixture gels.

In a preferred embodiment, a first time period is allowed in which the Lewis acid, the polyhydroxy moiety, and the monomer form a reactive complex, from about 1 to 3 hours. After the addition of the organic salt, the polymerization reaction itself may be allowed to continue for anywhere between about 30 minutes to about 72 hours. Typically, a time in the range of about 4 to 12 hours is allowed for this second polymerization stage.

The actual molecular weights achieved with different extended π-conjugated polymers can vary greatly, depending upon the monomer selected, the Lewis acid selected, the polyhydroxy moiety present, the time and temperature used for polymerization, the presence of one or more co-monomers, the amount of any supplemental solvent being used, and the like. Typically, however, the polymer produced by the process of the invention has a molecular weight within the range of about 80,000 to about 900,000 Daltons as measured by gel permeation chromatography (GPC) and relative to polystyene standards. More typically, the molecular weight is in the range of about 110,000 to about 700,00 Daltons and, most typically within the range of about 170,000 to about 250,000 Daltons. Preferably, the molecular weight is greater than about 50,000 Daltons and, even more preferably, the molecular weight exceeds about 100,000 Daltons.

Like molecular weights in terms of Daltons, the numbers of repeating units may also vary greatly. However, a typical range would be from about 25 to about 2,500 repeating units (RU), as shown by NMR and gel permeation chromatography (GPC) studies, more typically about 40 to about 800 RU and, most typically, from about 300 to about 700 RU.

However, what is significant is that the molecular weight achieved with a reaction mixture comprising the polyhydroxy moiety, whether covalently linked to the monomer or present in free form, is significantly higher than when the same reaction is run in the absence of such a moiety. That the molecular weight is so much higher would not have been expected. The polymerization process of the invention, preferably using an organic salt as an accelerator, also produces these higher molecular weights in unexpectedly short reaction times and under surprisingly mild conditions without the formation of unwanted side-products.

The process of the invention may be performed in either batchwise fashion or on a continuous basis.

The polymer of formula I can be isolated from the reaction mixture by conventional polymer techniques, such as by precipitating out, extraction with an immiscible solvent, evaporating off the solvent, filtration, crystallization and the like. One advantage of using a polyhydroxy moiety in the reaction mixture is that it is significantly more labile, both chemically and thermally, than the extended π-conjugated chain polymers produced by the process, potentially allowing its removal by diverse means, if desired. However, it should be noted that the continued presence of the polyhydroxy moiety may be a significant advantage. For example, it might be recognized by a biological system and thus may act as an interface between a protein and the π-conjugated polymer of the invention.

The polymers, as synthesized, are soluble in a variety of polar and slightly polar organic solvents. In strongly H-bonding solvents, such as methanol or DMF, the UV/visible spectra of the complexed polymers exhibit the fine structure indicative of intramolecular ordering, such as coplanarity of adjacent repeat units. In less-strongly H-bonding solvents, such as acetonitrile and methylene chloride, the polymers tend to exhibit a bathochromic λ^{max} shift of about 300 nm and fine structure indicative of intermolecular ordering, such as π-stacking within polymer chain aggregates. The molecular self-assembly can be reversed by acidification of the polymer solution or by chelation of the Lewis acid or metal ion using, for example, 2,2′-bipyridine or EDTA as a chelating agent. Spectroscopic evidence of this reversal consists of a dramatic decrease in solution extinction coefficient, typically accompanied by a strong hypsochromic λₘₐₓ shift.

It is believed that the polyhydroxy moiety, whether covalently bound and complexed or noncovalently complexed, introduces noncovalent intrachain and interchain order into the polymer. When the polymer is dissolved in polar, strongly hydrogen-bonding solvents, such as DMF, its maximum absorption wavelength typically ranges from about 250 to 400 nm (e.g., 310 nm to 388 nm), and the UV/visible spectrum exhibits a considerable degree of fine structure. This appears to be due to intrachain order in the form of coplanar RU sequences in independent chains. It is believed that these regions of coplanarity arise from hydrogen-bond formation between polyhydroxy moieties in neighboring RUs.

For example, the spectrum of commercially available poly(3-alkylthiophene) in DMF shows no fine structure and only a single absorption at about 270 nm, indicating a lack of noncovalent intrachain order. When the corresponding polymer comprising a polyhydroxy moiety is dissolved in less-strongly hydrogen-bonding solvents, such as acetonitrile, methylene chloride or propylene carbonate, the λₘₐₓ increases into the range of about 620-640 nm, and the spectrum fine structure is retained. It appears that this spectral behavior is caused by self-assembly of the polymer chains due to weak solvation. This aggregation encourages the formation of lengthy RU sequences that are coplanar. The self-assembly presumably occurs through interchain complexation by the Lewis acid cation, interchain π-stacking forces, and interchain hydrogen bonding between polyhydroxy moieties. The λₘₐₓ therefore increases.

The extended π-conjugated polymers made by the process of the invention may have significant applications as organic light-emitting diodes, an attractive alternative to liquid crystal display because they can yield displays that are brighter, lower cost, more energy efficient, and lighter. This method could thus be used for easy large-scale production of very high molecular weight conducting polymers, i.e., “molecular wires”, for construction and shipbuilding/repair applications, and for anticorrosion coatings. Films formed from these polymers may have measurable electrical resistivities in the range of about 900 to about 100 kΩ, when measured using a standard four-point probe. Preferably, the measurable resistivity is in the range from about 700 to about 300 kΩ. The reversible polymer self-assembly method could, therefore, be used to form sophisticated, highly ordered conducting structures of virtually any dimension.

### EXAMPLES

### Example 1

### Polymerization of Three Monomers

Example 1 comprises a set of three reactions, Reactions 1a-c, depicted below:

Reaction 1a: Synthesis of Poly(β-O-2-(3-thienylethyl Glucopyranoside)) Using Scandium Triflate

A 0.2M solution of scandium triflate (Sc(OTr)₃) (OTr═—CF₃SO₃) in propylene carbonate was prepared under a nitrogen atmosphere at 35° C., stirring until the scandium triflate was completely dissolved. The monomer β-O-2-(3-thienylethyl glucopyranoside) was then added, in an amount sufficient to give a 0.2M solution with respect to the monomer. The solution was stirred at 35° C. for an additional two hours, and then an amount of tetrabutylammonium hexafluorophosphate sufficient to give a 0.05M solution was added. The resulting reaction mixture was thoroughly sparged with nitrogen, and allowed to continue reacting for three hours, forming a dark blue viscous solution.

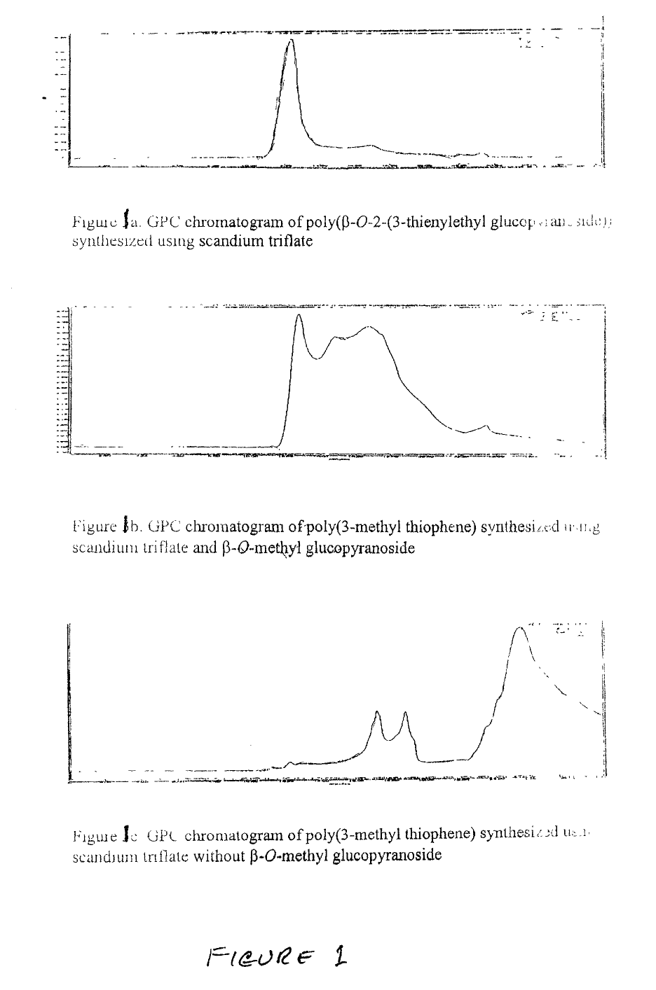

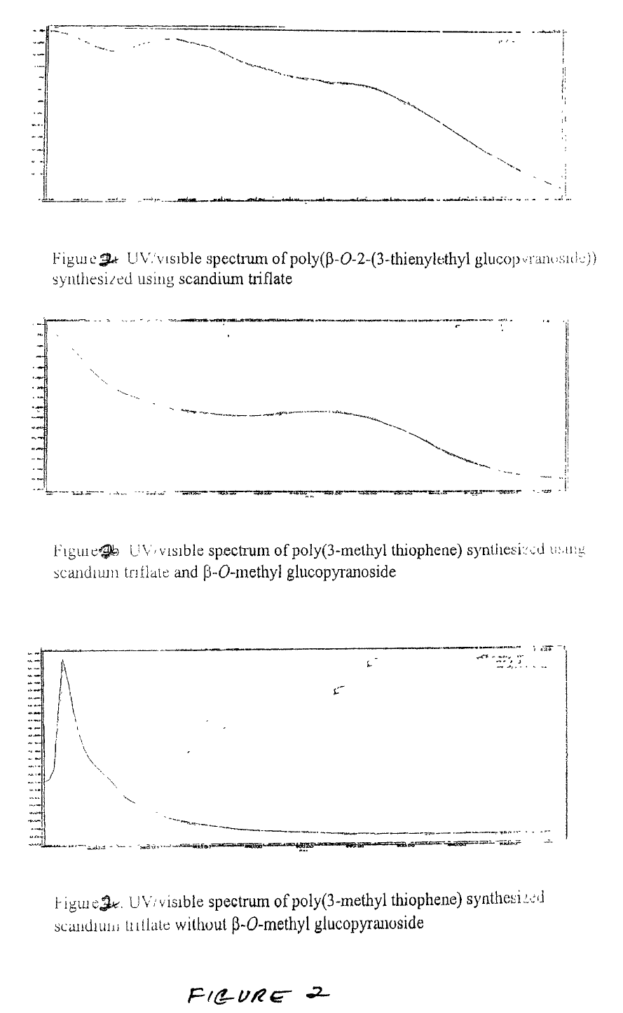

The molecular weight of the polymer and its spectrum was measured using GPC (FIG. 1a) with UV/visible recording and DMF as the mobile phase. The column retention time, about 12.4 minutes, corresponded to a molecular weight of about 260,000 Daltons relative to polystyrene standards, or about 780 repeat units. Conversion of the monomer to polymer was nearly quantitative. The polymer spectrum (FIG. 2a) showed a λₘₐₓ at 307 n and two intense, broad relative maxima at 373 and 475 nm. This considerable fine structure indicated the presence of order in the polymer, likely arising through extended π-conjugation.

Reaction 1b: Synthesis of Poly(3-Methyl Thiophene) Using Scandium Triflate and β-O-Methyl Glucopyranoside

A 0.2M solution of scandium triflate (Sc(OTr)₃) in propylene carbonate was prepared under nitrogen at 35° C., stirring until the scandium triflate was completely dissolved. The b-O-methyl glucopyranoside was then added, in an amount sufficient to give a 0.2M concentration with respect to the polyhydroxy moiety. The solution was stirred at 35° C. for an additional two hours, and then an amount of 3-methyl thiophene, sufficient to give a 0.3M concentration, was added. An amount of tetrabutylammonium hexafluorophosphate sufficient to give a 0.05M concentration was also added. The resulting solution was thoroughly sparged with nitrogen, and the reaction was allowed to proceed for 24 hours, forming a dark purple viscous solution.

The molecular weight and the spectrum of the polymer were measured using GPC (FIG. 1b) with UV/visible recording and DMF as the mobile phase. The column retention time, 12.75 minutes, corresponded to a molecular weight of about 120,000 Daltons relative to polystyrene standards, or about 360 repeat units (FIG. 1b). Oligomers with retention times of 14.70 and 16.70 minutes, corresponding to about 28 and 14 repeat units respectively, were also seen. The polymer spectrum (FIG. 2b) showed a small amount of fine structure, with a λₘₐₓ of 270 m and a broad relative maximum at 455 nm.

Reaction 1c: Synthesis of Poly(3-Methyl Thiophene) Using Scandium Triflate without β-O-Methyl Glucopyranoside

As a control experiment, a 0.2M solution of scandium triflate (Sc(OTr)₃) in propylene carbonate was prepared under nitrogen, stirring at 35° C. until the scandium triflate was completely dissolved. The solution was stirred at 35° C. for an additional two hours, and then an amount of 3-methyl thiophene, sufficient to give a 0.3M concentration of the monomer, and an amount of tetrabutylammonium hexafluorophosphate, sufficient to give a 0.05M solution, were added. The resulting reaction mixture was thoroughly sparged with nitrogen, and the reaction was allowed to proceed for 72 hours, forming a dark red solution. There was no change in solution viscosity during the reaction.

The reaction mixture was analyzed using GPC with UV/visible recording and DMF as the mobile phase. As seen in FIG. 1c, only a very small amount of oligomer was formed, with retention times corresponding to about 7 and 13 repeat units. A large amount of unreacted monomer was observed, having a retention time of about 27 minutes. The oligomer spectrum (FIG. 2c) showed a λₘₐₓ of 270 nm with virtually no fine structure and, therefore, exhibited no evidence of extended π-conjugation.

### Example 2

### Synthesis of Poly(3-4 Ethylenedioxythiophene) Using Scandium Triflate and β-O-Methyl Glucopyranoside

A 0.2M solution of scandium triflate (Sc(OTr)₃) in tetrahydrofuran was prepared under nitrogen, stirring at 35° C. until the scandium triflate was completely dissolved. The β-O-methyl glucopyranoside was then added, in an amount sufficient to give a 0.2M concentration. The solution was stirred at 35° C. for an additional two hours, and then an amount of 3,4-ethylenedioxythiophene, sufficient to give a 0.3M concentration, and an amount of tetrabutylammonium hexafluorophosphate, sufficient to give a 0.05M concentration, were added. The solution was then thoroughly sparged with nitrogen, and the reaction was allowed to proceed for ten hours, forming a dark blue viscous solution.

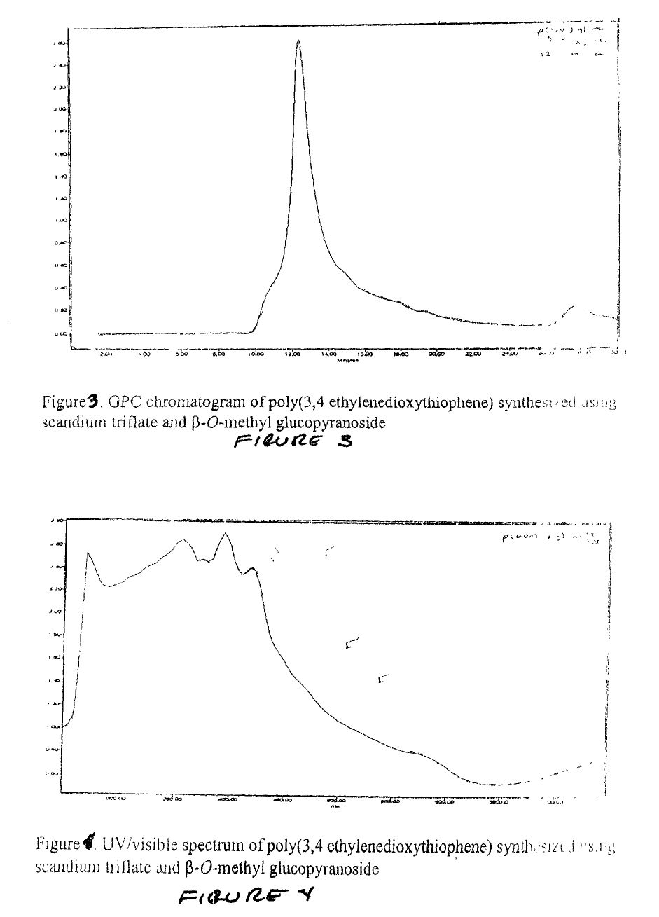

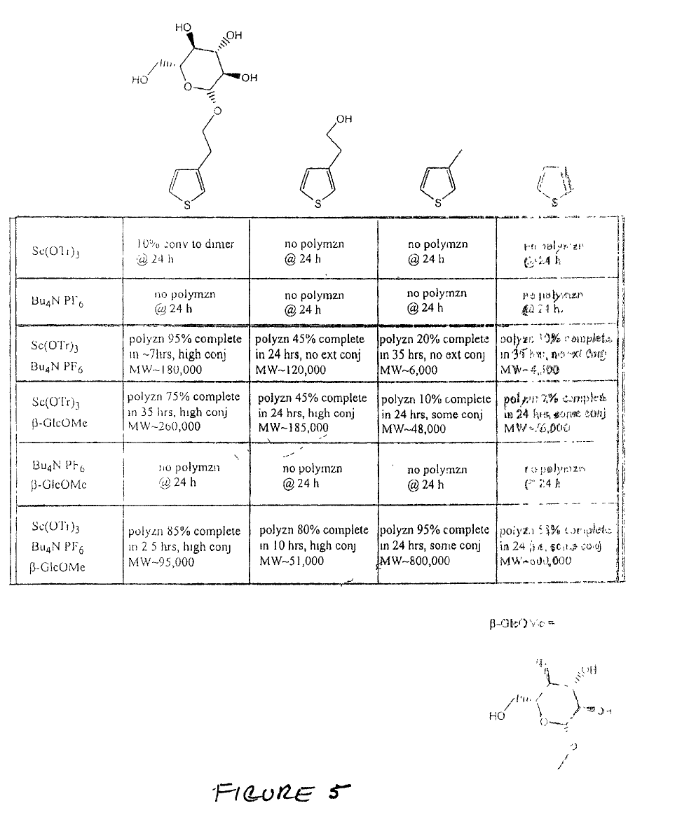

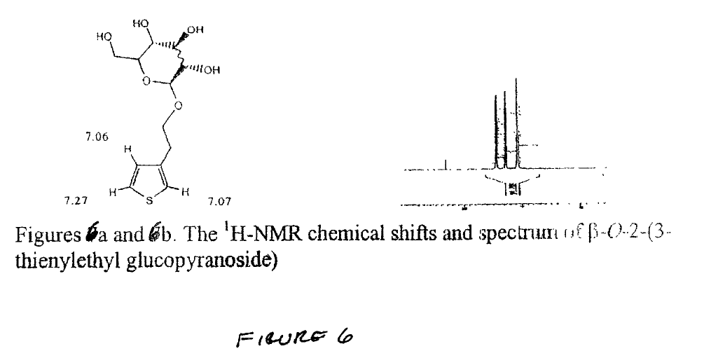

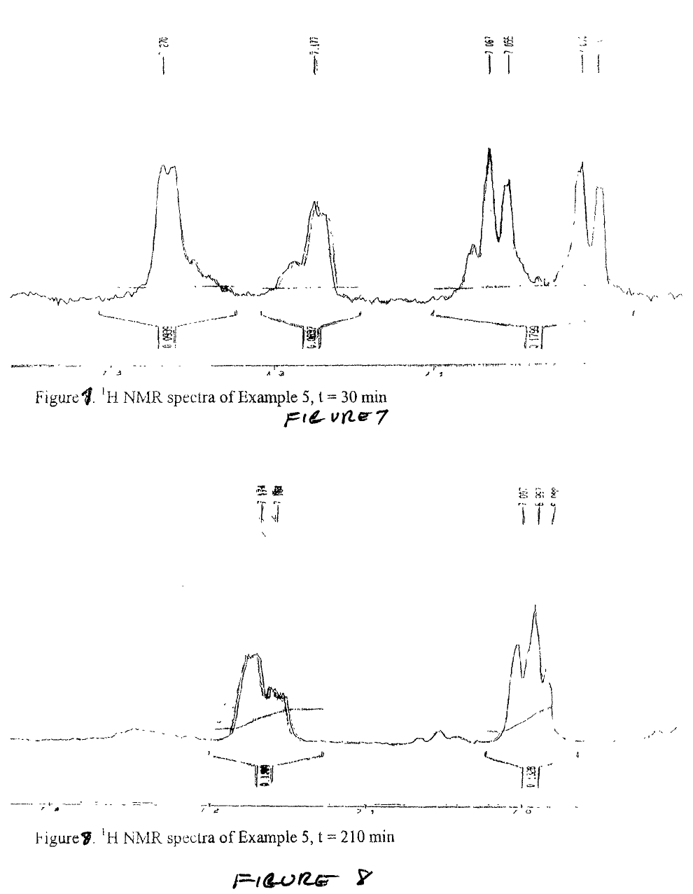

The molecular weight and spectrum of the polymer was measured using GPC with UV/visible recording and DMF as the mobile phase (FIG. 3). The column retention time of about 12.42 minutes corresponded to a molecular weight of about 240,000 relative to polystyrene standards, or about 630 repeat units. The polymer spectrum (FIG. 4) exhibited a large amount of fine structure, with an absolute λₘₐₓ at 388 nm and three relative maxima at 270, 353, and 415 nm.

### Example 3

### Matrix of Control Experiments

A series of control experiments was performed to ascertain the role of each chemical component in the above reactions. The results are shown in FIG. 5 in terms of (1) percent conversion of monomer to polymer/oligomer at the time the reaction was complete and (2) the degree of conjugation present in the polymer according to the UV/visible spectra.

In appropriate combinations, the control experiments used 0.1M scandium triflate (Sc(OTr)₃), 0.1M β-O-methyl glucopyranoside (β-GlcOMe), 0.1M monomer, and 0.05M tetrabutylammonium hexafluorophosphate (Bu₄N/PF₆), with propylene carbonate as the solvent. The reactions were performed under nitrogen at 35° C. and allowed to proceed for up to 48 hours. The molecular weight and spectrum of the resulting polymer was measured using GPC/UV/visible with DMF as the mobile phase.

The results summarized in FIG. 5 show that Sc(OTr)₃ alone was not effective as a polymerization catalyst. When the organic salt was introduced, Sc(OTr)₃ became marginally effective in this regard, but could only achieve low to moderate polymerization yields. Further, the polymers produced did not exhibit extended π-conjugation. However, in the presence of a polyhydroxy moiety, both yield and π-conjugation dramatically increased. The increase in yield is thought to be due to the increased solubility of the growing polymer chains provided by the polyhydroxy moiety in the presence of the Sc⁺⁺⁺ cation. The increase in π-conjugation is believed to be due to the increased amount of intramolecular H-bonding between polyhydroxy moieties different chains, which causes the extended ring system to become more planar and, thus, even more ordered and capable of adopting the desired quinoid form.

### Example 4

### Synthesis of Poly(β-O-2-(3-thienylethyl glucopyranoside)) Using Lanthanum Triflate

A 0.2M solution of lanthanum triflate (La(OTr)₃) in propylene carbonate was prepared under nitrogen and stirred at 35° C. until the triflate was completely dissolved. The monomer β-O-2-(3-thienylethyl glucopyranoside) was then added, in an amount sufficient to give a 0.2M solution. The solution was stirred at 35° C. for an additional two hours, and then an amount of tetrabutylammonium hexafluorophosphate, sufficient to give a 0.1M solution, was added. The resulting reaction mixture was thoroughly sparged with nitrogen, and the reaction was allowed to proceed for seven hours, forming a dark blue-green viscous solution.

The molecular weight and spectrum of the resulting polymer was measured using GPC with UV/visible recording and DMF as the mobile phase. The column retention times, about 12.6 minutes and 16.7 minutes, corresponded to about 400 repeat units and 10 repeat units respectively. Conversion of the monomer to polymer/oligomer was nearly quantitative.

### Example 5

### Evidence of Carbon-Carbon Bond Formation in Polymer Chain Extension and Determination of Oligo(β-O-2-(3-thienylethyl Glucopyranoside)) Minimum Chain Lengths using ¹H-NMR

A 0.2M solution of scandium triflate (Sc(OTr)₃) in propylene carbonate was prepared under nitrogen and stirred at 35° C. until completely dissolved. An amount of the monomer β-O-2-(3-thienylethyl glucopyranoside), sufficient to give a 0.2M solution, was then added. The solution was stirred at 35° C. for an additional two hours, and an amount of tetrabutylammonium hexafluorophosphate sufficient to give a 0.05M solution was added. The reaction mixture was thoroughly sparged with nitrogen. After the reaction had proceeded for about 30 minutes (t=30), a sample was taken, frozen by exposure to liquid nitrogen, and stored at −20° C. The remainder of the reaction mixture was then allowed to continue polymerizing for an additional three hours (t=210), and another sample was taken. Both the fresh sample and the frozen sample were heated under vacuum overnight at 50° C. to remove the propylene carbonate solvent. Both samples left a dark blue dried residue.

Both samples were mixed with d-THF and subjected to ¹H-NMR analysis. Although the residue from the completed reaction was not completely soluble, the GPC analysis showed no unreacted monomer.

The polymerization reaction was monitored by observation of the signal intensities associated with the protons at the 2- and 5- positions of the monomeric thiophene ring. As the reaction proceeded, these protons were apparently abstracted as the extended 2,5-linkages were formed, and the signal intensities corresponding to them were seen to decrease accordingly.

FIG. 6a depicts the monomer structure and the chemical shifts associated with each thiophene ring proton, and FIG. 6b shows the corresponding portion of the ¹H-NMR spectrum of β-O-2-(3-thienylethyl glucopyranoside) monomer. The shifts at 7.06, 7.07 and 7.27 ppm are associated with the protons at the 4-, 2- and 5-positions, respectively. For the reaction mixture at t=30 min, the spectral region at 7 ppm was expanded and is shown in FIG. 7. The peaks that have appeared at 7.00 and 7.01 ppm correspond to the proton at the 4-position, shifted upfield from 7.06 ppm. These two peaks result from two different 2-to-5 coupling patterns appearing in the oligomer. The protons at the 2-, 4- and 5positions of the unreacted monomer are still visible.

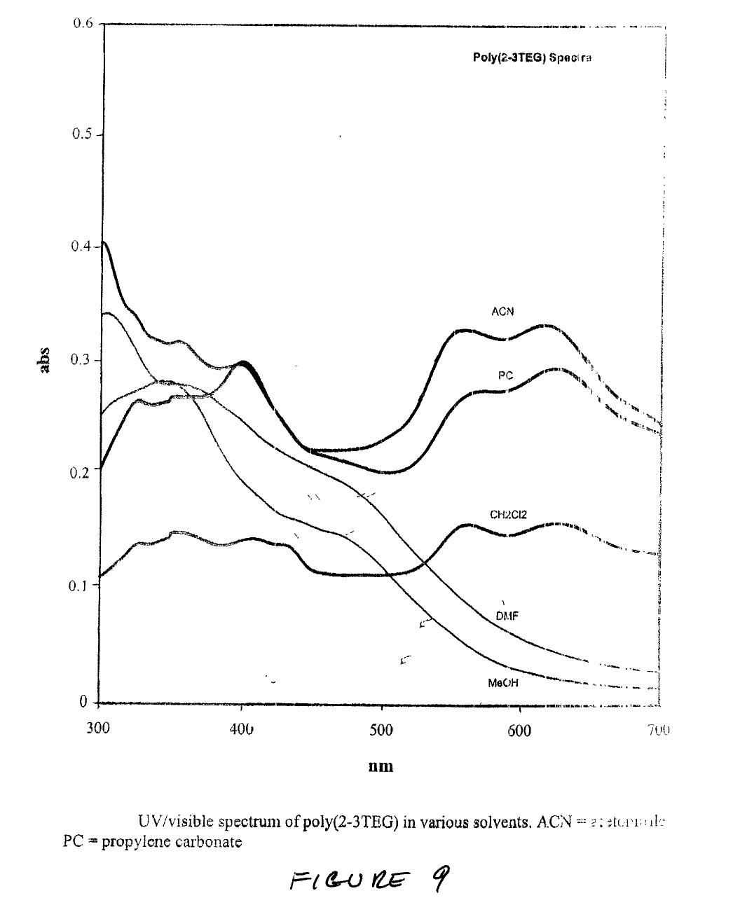

For the reaction mixture at t=210 min, the same spectral region was expanded and is shown in FIG. 8. An additional peak corresponding to the 4-proton appears at 6.99 ppm resulting from a third 2-to-5 coupling pattern that has emerged in the oligomer. Two small residual peaks remain at 7.07 and 7.06 ppm. The ratio of the 7.07 peak at t=30 min to that at t=210 min, i.e., about 28, gives a conservative estimate of the number of repeat units in the oligomeric product. When a similar analysis was applied to the peak at 7.27 ppm, the number of repeat units was calculated to be about 25. It should be noted, however, that these values could be considered only the lower limit of the oligomer/polymer length, since much of the dried product was insoluble in d-THF, and the insoluble fraction was likely to have been of even greater molecular weight.

### Example 6

### Electrical Conductivity of Poly (β-O-(2,3-dihydro-thieno[3,4-b][1,4]dioxin-2-yl)methyl Glucopyranoside) Synthesized Using Lanthanum Triflate

A 0.2M solution of lanthanum triflate (La(OTr)₃) in propylene carbonate was prepared under nitrogen and stirred at 35° C. until the triflate was completely dissolved. The solution was stirred at 35° C. for an additional two hours. An amount of β-O-(2,3 dihydro-thieno[3,4-b][1,4]dioxin-2-yl)methyl glucopyranoside, sufficient to give a 0.1M concentration, and an amount of tetrabutylammonium hexafluorophosphate, sufficient to give a 0.1M concentration, were added. The solution was then thoroughly sparged with nitrogen, and the reaction was allowed to proceed for four hours, forming a dark blue viscous solution.

The molecular weight and spectrum of the resulting polymer was measured using GPC with UV/visible recording and DMF as the mobile phase. The column retention times, about 12.45 minutes and 16.7 minutes, corresponded to molecular weights of 5,500 and 240,000 relative to polystyrene standards, or about 14 and 570 repeat units, respectively. Both polymer fractions were collected. Those containing the lower molecular weight material were pooled, and the DMF solvent was evaporated using nitrogen at 35° C.

The orange solid that remained was dissolved in THF and spin-coated onto silicon wafers at 500 RPM. The THF solvent was then removed by drying at 1001C for 1.5 minute. The resulting thin polymer film had a resistivity ranging from 466 to 149 kΩ, as measured by a standard four-point probe. This resistivity of the polymer provided persuasive evidence of extended π-conjugation in the polymer.

### Example 7

### Demonstration of Self-Assembly of Poly[β-O-2-(3-thienylethyl Glucopyranoside)]

Poly[β-O-2-(3-thienylethyl glucopyranoside)] was synthesized as described in Example 1. Five aliquots from the reaction were taken, and each was diluted in one of the following different solvents: acetonitrile, propylene carbonate, methylene chloride, DMF, and methanol. A typical dilution factor was about 1/5000.

The UV/visible spectra are given in FIG. 9, with the spectra of the less polar solvents shown in bold. The polymer chains were not strongly solvated in this less polar media, and thus tended to self-assemble, thereby increasing interchain order. The self-assembly is thought to have occurred through the complex formed by the Lewis acid cation and the polyhydroxy moiety, between chains and π-π interactions. Electron movement could then occur between neighboring chains, leading to very long conjugation lengths and high λₘₐₓ values.

In FIG. 9, the polymer spectra in the weakly H-bonding solvents acetonitrile, propylene carbonate, and methylene chloride exhibited extensive fine structure. The appearance of relative maxima at ˜320, 345, 400, 428, 555, and 625 nm was virtually independent of solvent. Each maximum represented a specific π-π* or π-π* electronic transition that has been associated with an extended quinone structure having a specific conjugation length.

The addition of HCl/H₂O to the solutions caused a dramatic, instantaneous increase in UV/visible transmission and an accompanying decrease in extinction coefficient. This is believed to have been caused by the breakup of the chain assemblies and protonation of the ring sulfur atoms. Careful titration using NaOH/H₂O caused a reversal of these effects.

In the strongly H-bonding solvents (DMF and methanol) the polymer chains were well-solvated and did not appear to self-assemble. As discussed in Example 1, they are thought to have experienced noncovalent intrachain interactions that enhance the formation of small quinoid domains, having λₘₐₓ values at shorter wavelengths.

The invention being thus described, it will be obvious that the same may be varied in many ways. Such variations are not to be regarded as a departure from the spirit and scope of the invention, and all such modifications are intended to be included within the scope of the following claims.

What is claimed is:

1. A process for preparing a high molecular weight, extended π-conjugated polymer from a monomer comprising a heterocyclic, benzylic or phenolic ring, the process comprising the step of reacting a Lewis acid with:
a. the monomer and
b. a polyhydroxy moiety, said polyhydroxy moiety being linked covalently to the monomer or present in free form.

2. The process of claim 1 wherein the monomer comprises a thiophene, pyrrole, furan or hydroquinone ring.

3. The process of claim 1 wherein the monomer comprises a thiophene ring.

4. The process of claim 1 wherein the monomer is selected from the group is consisting of 3-methyl thiophene, 3,4-ethylenedioxy thiophene, β-O-2-(3-thienylethyl) glucopyranoside, and β-O-2-(2,3 dihydro-thieno[3,4-b][1,4]dioxin-yl)methyl) glucopyranoside.

5. The process of claim 1 wherein the Lewis acid comprises a metal cation having a valence of +3.

6. The process of claim 1 wherein the Lewis acid comprises a cation selected from the group consisting of Group 3 elements and the Lanthanides.

7. The process of claim 1 wherein the Lewis acid cation is selected from the group consisting of scandium and lanthanum.

8. The process of claim 1 wherein the Lewis acid anion is a trifluoromethane sulfonate (“triflate”) anion.

9. The process of claim 1 wherein the polyhydroxy moiety is a hexopyranose.

10. The process of claim 1 wherein the polyhydroxy moiety is β-O-methyl glucopyranoside.

11. The process of claim 1 wherein the reaction mixture also comprises an organic salt.

12. The process of claim 11 wherein the organic salt is tetrabutylammonium hexafluorophosphate.

13. The process of claim 1 wherein the polyhydroxy moiety is covalently linked to the monomer.

14. The process of claim 1 wherein the polyhydroxy moiety is in free noncovalently linked form.

15. The process of claim 1 wherein the reaction mixture also comprises a polar solvent.

16. The process of claim 15 wherein said polar solvent is propylene carbonate or tetrahydrofuran.

18. The process of claim 1 wherein said polymer has a molecular weight greater than about 50,000 Daltons as measured by GPC.

19. The process of claim 1 wherein said polymer has a molecular weight greater than about 100,000 Daltons as measured by GPC.

20. The process of claim 1 wherein said polymer has a molecular weight within the range of about 80,000 to about 900,000 Daltons as measured by GPC.

21. The process of claim 1 wherein said polymer has a molecular weight within the range of about 110,000 to about 700,000 Daltons as measured by GPC.

22. The process of claim 1 wherein said polymer has a molecular weight within the range of about 170,000 to about 250,000 Daltons as measured by GPC.

23. The process of claim 1 wherein the number of repeat units in said polymer ranges from about 25 to about 2,500, as measured by NMR or GPC studies.

24. The process of claim 1 wherein the number of repeat units in said polymer ranges from about 40 to about 800 repeat units, as measured by NMR or GPC studies.

25. The process of claim 1 wherein the number repeat units of said polymer ranges from about 300 to about 700 repeat units, as measured by NMR or GPC studies.

26. The process of claim 1 wherein said polymer exhibits a resistivity in the range from about 900 to about 100 kΩ.

27. The process of claim 1 wherein said polymer has a resistivity ranging from about 700 to about 300 kΩ.

28. The process of claim 1 wherein a UV/visible spectrum of a solution of said polymer in a hydrogen-bonding solvent exhibits a bathochromic shift as the solvent becomes less-strongly hydrogen bonding.
